(19) United States
(12) Patent Application Publication
(10) Pub. No.: US 2025/0270387 A1
(43) Pub. Date: Aug. 28, 2025

(54) Halogen Free Flame Retardant Polyamide Composite With Improved Glow Wire Performance

(71) Applicant: Celanese Polymers Holding, Inc., Wilmington, DE (US)

(72) Inventor: Xilong Hu, Shanghai (CN)

(21) Appl. No.: 19/063,793

(22) Filed: Feb. 26, 2025

Related U.S. Application Data
(60) Provisional application No. 63/558,186, filed on Feb. 27, 2024.

(51) Int. Cl. C08K 13/04; C08K 3/32; C08K 5/06; C08K 5/3492; C08K 5/3495; C08K 5/5313; C08K 7/14; C08L 77/06; H01B 3/30; H01R 13/46

(52) U.S. Cl. CPC C08K 13/04; C08L 77/06; H01B 3/305; H01R 13/46; C08K 3/32; C08K 5/06; C08K 5/34922; C08K 5/3495; C08K 5/5313; C08K 7/14; C08K 2201/014; C08L 2201/02; C08L 2201/08; C08L 2205/025

(57) ABSTRACT

A polyamide composition comprising a polyamide; a plurality of inorganic fibers; and a flame retardant system is disclosed. At a thickness of 0.8 mm, the composition exhibits a Glow Wire Ignition Temperature of about 775° C. or more as determined in accordance with IEC-60695-2-13:2010.

### RELATED APPLICATIONS

The present application is based upon and claims priority to U.S. Provisional Patent Application Ser. No. 63/558,186, having a filing date of Feb. 27, 2024, which is incorporated herein by reference in its entirety.

### BACKGROUND

Electrical connectors are commonly used in household and industrial appliances to provide a connection between the product and an electrical circuit, or between different components within the product itself. Due to their small size and complex geometry, many of these electrical connectors are formed from polyamide compositions. Recently, the International Electrotechnical Commission (IEC) has adopted the ignition resistance in several electrical safety standards (IEC 60335-1 and the second parts of the same) to assess the safety of electrical end products. This comes to integrate the existing requirements of resistance to heat and fire for polyamide compositions and other resins used in components for appliances when they are used as an insulating material. Applicable ignition and combustion resistance tests are described in the “glow wire” standards (IEC 60695-2/10/11/12/13). Because polyamide compounds, especially when reinforced with glass fibers, have a relative low degree of inherent ignition resistance, most conventional attempts in satisfying these glow wire standards have involved the addition of external halogen-based flame retardants (e.g., brominated compounds) to the polyamide composition. Unfortunately, however, the presence of halogens is not desired in most electrical applications due to environmental concerns when the composition is burned. While halogen-free flame retardants have been developed, the use of such materials in polyamide resins is typically associated with a corresponding adverse impact on the mechanical properties of the composition.

As such, a need currently exists for flame retardant polyamide compositions that can satisfy the IEC glow wire requirements without the need for halogen-based flame retardants, but still maintain good mechanical properties (e.g., similar to equivalent grades without flame retardants), as well as other properties, such as elevated CTI and good insulation properties.

### SUMMARY

In accordance with one embodiment of the present invention, a polyamide composition is disclosed that comprises a polyamide, a plurality of inorganic fibers, and a flame retardant system comprising a metal phosphinate and a nitrogen-containing synergist. At a thickness of 0.8 mm, the composition exhibits a Glow Wire Ignition Temperature of about 775° C. or more as determined in accordance with IEC-60695-2-13:2010, a V0 rating as determined in accordance with UL94, and/or a comparative tracking index of about 550 volts or more as determined in accordance with IEC 60112:2003. In accordance with the present disclosure, the nitrogen-containing synergist is comprised of a nitrogen compound that displays less than 1% weight loss under a nitrogen atmosphere at a temperature of from 200° C. to 300° C., such as from 200° C. to 400° C. The nitrogen-containing synergist is contained in the composition in an amount from about 1% by weight to about 30% by weight, such as in an amount of from about 3% by weight to about 20% by weight, such as in an amount from about 8% by weight to about 18% by weight. In one embodiment, the nitrogen-containing synergist comprises melam, melem, or mixtures thereof.

The polyamide can comprise an aliphatic polyamide, a semi-aromatic polyamide, a wholly aromatic polyamide, or mixtures thereof. In one embodiment, the polyamide comprises an aliphatic polyamide in combination with a semi-aromatic polyamide. The aliphatic polyamide, for instance, may comprise polyamide 6,6. The semi-aromatic polyamide, on the other hand, may comprise polyamide 6I/6T. One or more polyamides can be present in the polymer composition generally in an amount from about 30% by weight to about 80% by weight. In one aspect, an aliphatic polyamide can be present in the polymer composition in an amount from about 20% to about 60% by weight. A semi-aromatic polyamide can be present in the polymer composition in an amount from about 2% by weight to about 20% by weight, such as in an amount from about 3% by weight to about 12% by weight.

The metal phosphinate of the flame retardant system, in one embodiment, comprises an aluminum phosphinate, such as aluminum diethylphosphinate. The flame retardant system can further contain a metal salt, such as an aluminum salt having the following chemical structure:

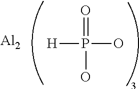

The aluminum salt can comprise dialuminum tris(hydrogen phosphite). The metal phosphinate can be present in the polymer composition in an amount from about 5% to about 30% by weight, such as in an amount from about 7% to about 20% by weight, such as in an amount from about 8% to about 12% by weight. The metal salt, on the other hand, can be present in the polymer composition in an amount from about 0.8% by weight to about 6% by weight, such as in an amount from about 1.75% by weight to about 4% by weight.

In one aspect, the polymer composition can further comprise a heat stabilizer. For instance, the heat stabilizer can comprise dipentaerythritol. The heat stabilizer can be present in the polymer composition in an amount greater than about 0.5% by weight, such as in an amount greater than about 1% by weight, such as in an amount greater than about 1.3% by weight, and in an amount less than about 5% by weight, such as in an amount less than about 3% by weight.

The reinforcing fibers present in the polymer composition can comprise glass fibers. The glass fibers can be present in the polymer composition generally in an amount from about 5% by weight to about 50% by weight, such as in an amount from about 25% by weight to about 35% by weight.

In one particular embodiment, the polymer composition contains about 20% by weight to about 45% by weight of polyamide 6,6 or polyamide 6, contains from about 5% by weight to about 10% by weight of polyamide 6I/6T, contains from about 7% by weight to about 15% by weight of an aluminum phosphinate, contains from about 1.5% by weight to about 4% by weight of dialuminum tris(hydrogen phosphate), contains from about 25% by weight to about 35% by weight of glass fibers, contains from about 8% by weight to about 17% by weight of melam, melem, or mixtures thereof and can optionally contain from about 0.8% by weight to about 3% by weight of a heat stabilizer.

In accordance with another embodiment of the present invention, the present disclosure is directed to an electrical connector that comprises opposing walls between which a passageway is defined for receiving a contact pin. At least one of the walls has a thickness of about 4 millimeters or less and contains a polyamide composition comprising a polyamide and glass fibers, wherein the composition exhibits a Glow Wire End Product Temperature (without flame) of about 750° C. or more as determined in accordance with IEC-60335-1:2010, a V0 rating as determined in accordance with UL94, and/or a comparative tracking index of about 550 volts or more, such as 600 volts or more as determined in accordance with IEC 60112:2003.

Other features and aspects of the present invention are set forth in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a connector that may be made in accordance with the present disclosure; and

FIG. 2 is a perspective view of another embodiment of a connector that may be made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present invention.

Generally speaking, the present invention is directed to a polyamide composition that contains at least one polyamide resin in combination with inorganic fibers and a flame retardant system that includes a metal phosphinate, a metal phosphite, and a nitrogen-containing synergist. Typically, polyamides constitute from about 30 wt. % to about 80 wt. %, in some embodiments from about 35 wt. % to about 75 wt. %, and in some embodiments, from about 40 wt. % to about 70 wt. % of the composition. Inorganic fibers may constitute from about 5 wt. % to about 50 wt. %, in some embodiments from about 10 wt. % to about 40 wt. %, and in some embodiments, from about 25 wt. % to about 35 wt. % of the composition. Likewise, the flame retardant system typically constitutes from about 5 wt. % to about 40 wt. %, in some embodiments from about 10 wt. % to about 40 wt. %, and in some embodiments, from about 15 wt. % to about 35 wt. % of the polyamide composition.

Through selective control over the nature of these and relative concentration of these components, the present inventors have discovered that the resulting polyamide composition can achieve a unique combination of flame retardancy and good mechanical properties even when formed into a shape part having a relatively small thickness, such as about 4 millimeters or less, in some embodiments about from about 0.2 to about 3.2 millimeters or less, and in some embodiments, from about 0.4 to about 1.6 millimeters (e.g., 0.4 or 0.8 millimeters).

As is known in the art, the flame retardancy of the composition can be characterized by glow wire testing. For example, during glow wire testing, the temperature at which the composition will ignite and burn for longer than 5 seconds when placed into contact with a heated test plate can be measured. This temperature is known as the Glow Wire Ignition Temperature (“GWIT”) and is determined in accordance with IEC-60695-2-13:2010 at a part thickness such as noted above (e.g., from about 0.4 to about 3.2 millimeters). Generally speaking, the composition of the present invention can exhibit a GWIT of about 750° C. or more, in some embodiments about 775° C. or more, and in some embodiments, about 800° C. or more.

In addition to the glow wire test, the flammability of the composition of the present invention can also be characterized in accordance the procedure of Underwriter's Laboratory Bulletin 94 entitled “Tests for Flammability of Plastic Materials, UL94.” Several ratings can be applied based on the time to extinguish ((total flame time of a set of 5 specimens) and ability to resist dripping as described in more detail below. According to this procedure, for example, the composition may exhibit a V0 rating at a part thickness such as noted above (e.g., from about 0.4 to about 3.2 millimeters), which means that it has a total flame time of about 50 seconds or less. To achieve a V0 rating, the composition may also exhibit a total number of drips of burning particles that ignite cotton of 0.

The composition of the present invention may also exhibit a comparative tracking index (“CTI”) that is relatively high when determined in accordance with IEC 60112:2003 at a part thickness such as noted above. For example, the composition may exhibit a CTI that is about 550 volts or more, in some embodiments about 575 volts or more, in some embodiments about 600 volts or more.

Conventionally, it was believed that compositions having flame retardant properties could not achieve the desired mechanical properties for various applications. The present inventors have discovered, however, that the composition of the present invention can still achieve good impact strength, tensile properties, and flexural properties. For example, the polyamide composition may exhibit a Charpy unnotched impact strength of about 5 KJ/m² or more, in some embodiments about 7 KJ/m² or more, in some embodiments from about 8 to about 30 KJ/m², and in some embodiments, from about 8 to about 25 KJ/m², measured at 23° C. according to ISO Test No. 179-1:2010 (technically equivalent to ASTM D256-10, Method B). The composition may also exhibit a tensile strength or stress at break of about 100 Megapascals (“MPa”) or more, in some embodiments about 120 MPa or more, in some embodiments from about 130 to about 200 MPa, and in some embodiments, from about 140 to about 200 MPa, as well as a tensile modulus of about 9,000 MPa or more, in some embodiments about 10,000 MPa or more, in some embodiments about 11,000 MPa or more, in some embodiments from about 10,000 to about 50,000 MPa, and in some embodiments, from about 11,000 to about 25,000 MPa, wherein the tensile properties are determined in accordance with ISO Test No. 527:2012 (technically equivalent to ASTM D638-14 at 23° C.

Various embodiments of the present invention will now be described in more detail.

### I. Polyamide Composition

### A. Polyamide

Polyamides generally have a CO—NH linkage in the main chain and are obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth. Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide is employed that is formed only from aliphatic monomer units (e.g., diamine and dicarboxylic acid monomer units). Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable.

It is also possible to include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), polyamide 6I/6T, poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephlhalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene lerephthalamide/dodecamelhylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

In one particular embodiment, the polymer composition contains an aliphatic polyamide, such as polyamide 6 and/or polyamide 6,6 in combination with a semi-aromatic polyamide comprising polyamide 6I/6T.

Notably, the polyamides disclosed herein may be homopolymers and/or copolymers. The homopolymers and copolymers are identified by their respective repeat units. The following list exemplifies the abbreviations used to identify monomers and repeat units in the homopolymer polyamides and the copolymer polyamides:

TABLE

| Abbreviation | Description |
|---|---|
| HMD | hexamethylene diamine (or 6 when used in |
| | combination with a diacid) |
| T | Terephthalic acid |
| AA | Adipic acid |
| DMD | Decamethylenediamine |
| DDA | Decanedioic acid |
| DDDA | Dodecanedioic acid |
| I | Isophthalic acid |
| 6I | Polymer repeat unit formed from HMD and I |
| MXD | meta-xylylene diamine |
| 2-MPMD | 2-methylpentamethylenediamine |
| TMD | 1,4-tetramethylene diamine |
| 4T | polymer repeat unit formed from TMD and T |
| 6T | polymer repeat unit formed from HMD and T |
| DT | polymer repeat unit formed from 2-MPMD and T |
| MXD6 | polymer repeat unit formed from MXD and AA |
| 66 | polymer repeat unit formed from HMD and AA |
| 10T | polymer repeat unit formed from DMD and T |
| 410 | polymer repeat unit formed from TMD and DDA |
| 510 | polymer repeat unit formed from 1,5- |
| | pentanediamine and DDA |
| 610 | polymer repeat unit formed from HMD and DDA |
| 612 | polymer repeat unit formed from HMD and DDDA |
| 6 | polymer repeat unit formed from |
| | ^{€}-caprolactam |
| 11 | polymer repeat unit formed from 11- |
| | aminoundecanoic acid |
| 12 | polymer repeat unit formed from 12- |
| | aminododecanoic acid |

The table above exemplifies the abbreviations used to identify monomers and repeat units in polyamide homopolymers and copolymers. The polymer composition can contain any of the above homopolymers and/or copolymers.

The polyamide employed in the polyamide composition is typically crystalline or semi-crystalline in nature and thus has a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2013 (glass transition) and 11357-3:2011 (melting).

In general, one or more polyamides can be present in the polymer composition in an amount from about 20% by weight to about 80% by weight, such as in an amount from about 30% by weight to about 80% by weight, such as in an amount from about 25% by weight to about 55% by weight.

In one aspect, from about 50% by weight to about 100% by weight of the polyamides present in the polymer composition comprise aliphatic polyamides while from 0% by weight to about 50% by weight of the polyamides present in the polymer composition can comprise a semi-aromatic polyamide. In one aspect, an aliphatic polyamide, such as polyamide 6, polyamide 6,6, or combinations thereof can be present in the polymer composition in an amount from about 20% by weight to about 45% by weight, such as in an amount from about 30% by weight to about 40% by weight. A semi-aromatic polyamide can be present in the polymer composition, such as polyamide 6I/6T, in an amount from about 5% by weight to about 10% by weight, such as in an amount from about 6% by weight to about 9% by weight.

### B. Inorganic Fibers

The inorganic fibers generally have a high degree of tensile strength relative to their mass. For example, the ultimate tensile strength of the fibers (determined in accordance with ASTM D2101) is typically from about 1,000 to about 15,000 MPa, in some embodiments from about 2,000 MPa to about 10,000 MPa, and in some embodiments, from about 3,000 MPa to about 6,000 MPa. The high strength fibers may be formed from materials that are also electrically insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof. The inorganic fibers may have a relatively small median diameter, such as about 50 micrometers or less, in some embodiments from about 0.1 to about 40 micrometers, and in some embodiments, from about 2 to about 20 micrometers, such as determined using laser diffraction techniques in accordance with ISO 13320:2009 (e.g., with a Horiba LA-960 particle size distribution analyzer). It is believed that the small diameter of such fibers can allow their length to be more readily reduced during melt blending, which can further improve surface appearance and mechanical properties. After formation of the polymer composition, for example, the average length of the inorganic fibers may be relatively small, such as from about 10 to about 800 micrometers, in some embodiments from about 100 to about 700 micrometers, and in some embodiments, from about 200 to about 600 micrometers. The inorganic fibers may also have a relatively high aspect ratio (average length divided by nominal diameter), such as from about 1 to about 100, in some embodiments from about 10 to about 60, and in some embodiments, from about 30 to about 50.

In one aspect, glass fibers can be present in the polymer composition in an amount from about 5% by weight to about 40% by weight. For instance, glass fibers can be present in an amount greater than about 15% by weight, such as in an amount greater than about 20% by weight, such as in an amount greater than about 25% by weight, and in an amount less than about 40% by weight, such as in an amount less than about 35% by weight.

### C. Flame Retardant System

In addition to the components above, the polyamide composition also contains a flame retardant system that is capable of achieving the desired flammability performance, smoke suppression, and mechanical properties without the need for conventional halogen-based flame retardants. Consequently, the flame retardant system includes at least one low halogen flame retardant.

In this regard, the flame retardant system includes a metal phosphinate as one type of a halogen-free flame retardant. The metal phosphinate, for instance, may be a dialkyl phosphinate and/or a diphosphinate. The metal phosphinate may have one of the following chemical structures:

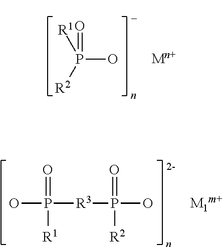

in which R¹, R² are the same or different and are each linear or branched C₁-C₆-alkyl; R³ is linear or branched C₁-C₁₀-alkylene, C₆-C₁₀-arylene, C₇-C₂₀-alkylarylene or C₇-C₂₀-arylalkylene; M is Mg, Ca, Al, Sb, Sn, Ge, Ti, Zn, Fe, Zr, Ce, Bi, Sr, Mn, Li, Na, K and/or a protonated nitrogen base; m is 1 to 4; n is 1 to 4; x is 1 to 4.

In one aspect, the metal phosphinate is a metal dialkylphosphinate, such as aluminum diethylphosphinate.

The metal phosphinate can be present in the polymer composition in an amount from about 5% to about 30% by weight including all increments of 1% by weight therebetween. For instance, the metal phosphinate can be present in an amount greater than about 7% by weight, such as in an amount greater than about 8% by weight, such as in an amount greater than about 9% by weight, and in an amount less than about 20% by weight, such as in an amount less than about 18% by weight, such as in an amount less than about 15% by weight, such as in an amount less than about 12% by weight.

The flame retardant system can also include a metal salt of a phosphite, which can also be referred to as a metal salt of a hydrogen phosphite. In one aspect, the metal salt can comprise dialuminum tris(hydrogen phosphite) and can have the following chemical structure:

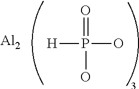

The metal salt of the hydrogen phosphite can be present in the polymer composition in an amount greater than about 0.5% by weight, such as in an amount greater than about 0.75% by weight, such as in an amount greater than about 1% by weight, such as in an amount greater than about 1.25% by weight, such as in an amount greater than about 1.5% by weight, such as in an amount greater than about 1.75% by weight, such as in an amount greater than about 2% by weight, such as in an amount greater than about 2.25% by weight. The metal salt is generally present in an amount less than about 10% by weight, such as in an amount less than about 8% by weight, such as in an amount less than about 6% by weight, such as in an amount less than about 4% by weight, such as in an amount less than about 3% by weight.

The flame retardant system can also comprise a nitrogen-containing synergist. In accordance with the present disclosure, the nitrogen-containing synergist is particularly selected such that the nitrogen compound displays less than 1% weight loss under a nitrogen atmosphere at a temperature of at least 200° C. For instance, the nitrogen-containing synergist can display a less than 1% weight loss under nitrogen atmosphere at a temperature of from 200° C. to 300° C., such as from 200° C. to 400° C. (e.g. 200° C., 300° C., or 400° C.). Weight loss in a nitrogen atmosphere is measured using thermogravimetric analysis. Suitable instruments for conducting thermogravimetric analysis are available from Texas Instruments. One particular model is the Q500 thermogravimetric analysis device and/or can include the Universal V4.5A instrument. In conducting the thermogravimetric analysis, the gas is selected as nitrogen. The device is equilibrated at 30° C. and temperature is ramped at 20° C. per minute to 600° C. The isothermal is for one minute.

Particular examples of nitrogen-containing synergists that may be incorporated into the polymer composition include melam, melem, and mixtures thereof.

The nitrogen-containing synergist can be present in the polymer composition in an amount from about 1% by weight to about 30% by weight, including all increments of 1% by weight therebetween. For instance, the nitrogen-containing synergist can be present in the polymer composition in an amount greater than about 3% by weight, such as in an amount greater than about 5% by weight, such as in an amount greater than about 8% by weight, such as in an amount greater than about 10% by weight, and in an amount less than about 25% by weight, such as in an amount less than about 20% by weight, such as in an amount less than about 18% by weight, such as in an amount less than about 16% by weight, such as in an amount less than about 14% by weight.

### D. Other Components

A wide variety of additional additives can also be included in the polyamide composition, such as impact modifiers, compatibilizers, particulate fillers (e.g., mineral fillers), lubricants, pigments, antioxidants, light stabilizers, heat stabilizers, and/or other materials added to enhance properties and processability. In certain embodiments, for example, the composition may contain a UV stabilizer. Suitable UV stabilizers may include, for instance, benzophenones, benzotriazoles (e.g., 2-(2-hydroxy-3,5-di-α-cumylphenyl)-2H-benzotriazole (TINUVIN® 234), 2-(2-hydroxy-5-tert-octylphenyl)-2H-benzotriazole (TINUVIN® 329), 2-(2-hydroxy-3-α-cumyl-5-tert-octylphenyl)-2H-benzotriazole (TINUVIN® 928), etc.), triazines (e.g., 2,4-diphenyl-6-(2-hydroxy-4-hexyloxyphenyl)-s-triazine (TINUVIN® 1577)), sterically hindered amines (e.g., bis(2,2,6,6-tetramethyl-4-piperidyl) sebacate (TINUVIN® 770) or a polymer of dimethyl succinate and 1-(2-hydroxyethyl)-4-hydroxy-2,2,6,6-tetramethyl-4-piperidine (TINUVIN®622)), and so forth, as well as mixtures thereof. When employed, such UV stabilizers typically constitute from about 0.05 wt. % to about 2 wt. % in some embodiments from about 0.1 wt. % to about 1.5 wt. %, and in some embodiments, from about 0.2 wt. % to about 1.0 wt. % of the composition.

In one embodiment, the polymer composition contains a heat stabilizer. The heat stabilizer, for instance, can comprise dipentaerythritol. The heat stabilizer can be present in the polymer composition in an amount greater than about 0.3% by weight, such as in an amount greater than about 0.5% by weight, such as in an amount greater than about 0.7% by weight, such as in an amount greater than about 1% by weight, such as in an amount greater than about 1.2% by weight, such as in an amount greater than about 1.4% by weight, and in an amount less than about 5% by weight, such as in an amount less than about 3% by weight, such as in an amount less than about 2% by weight, such as in an amount less than about 1.8% by weight.

In general, other additives and fillers, processing stabilizers, lubricants, and the like can be present in the polymer composition in an amount from about 0.01% by weight to about 60% by weight.

### II. Formation

The polyamide, inorganic fibers, flame retardant system, and other optional additives may be melt processed or blended together. The components may be supplied separately or in combination to an extruder that includes at least one screw rotatably mounted and received within a barrel (e.g., cylindrical barrel) and may define a feed section and a melting section located downstream from the feed section along the length of the screw. The fibers may optionally be added a location downstream from the point at which the polyamide is supplied (e.g., hopper). If desired, the flame retardant(s) may also be added to the extruder a location downstream from the point at which the polyamide is supplied. One or more of the sections of the extruder are typically heated, such as within a temperature range of from about 200° C. to about 450° C., in some embodiments, from about 220° C. to about 350° C., and in some embodiments, from about 250° C. to about 350° C. to form the composition. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

Regardless of the particular manner in which it is formed, the resulting polyamide composition can possess excellent thermal properties. For example, the melt viscosity of the polyamide composition may be low enough so that it can readily flow into the cavity of a mold having small dimensions. In one particular embodiment, the polyamide composition may have a melt viscosity of from about 400 to about 1,000 Pascal-seconds (“Pa-s”), in some embodiments from about 450 to about 900 Pa-s, and in some embodiments, from about 500 to about 800 Pa-s, determined at a shear rate of 1000 seconds⁻¹. Melt viscosity may be determined in accordance with ISO Test No. 11443:2005 at a temperature that is 15° C. higher than the melting temperature of the composition (e.g., 285° C.).

### III. Shaped Parts

Shaped parts may be formed from the polyamide composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polyamide composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polyamide composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

Regardless of the shaping technique employed, a wide variety of parts may be formed from the polyamide composition of the present invention. For example, the present inventors have discovered that the polyamide composition is particularly suitable for use in electrical connectors, such as those employed in household appliances. The connector may contain insertion passageways that are configured to receive contact pins. These passageways are defined by opposing walls, which may be formed from the polyamide composition of the present invention. The walls may have a width of from about 500 micrometers or less, in some embodiments from about 100 to about 450 micrometers, and in some embodiments, from about 200 to about 400 micrometers.

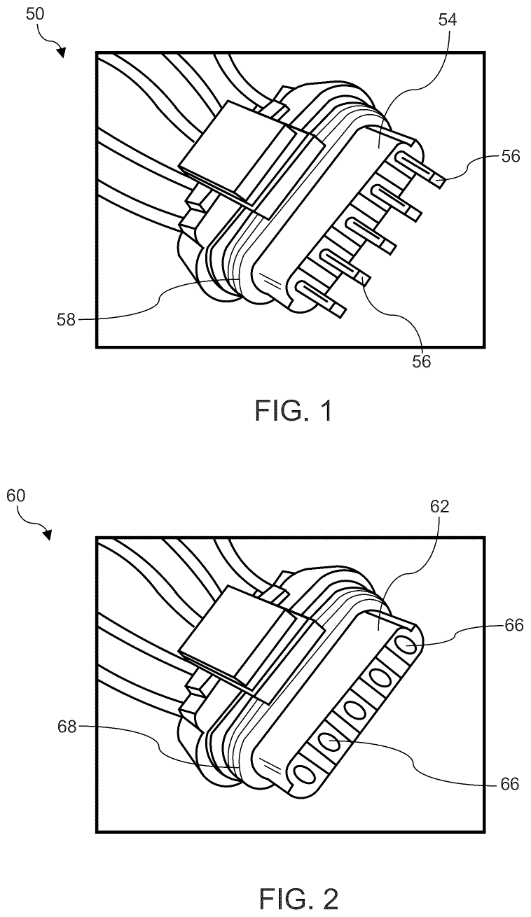

Referring to FIGS. 1 and 2, embodiments of electrical connectors that can be made in accordance with the present disclosure are shown.

Referring to FIG. 1, one embodiment of a high-voltage connector 50 that may be made in accordance with the present disclosure is shown. The electrical connector 50 includes a plurality of contact elements 56 extending from a base 54. The contact elements 56 are for making an electrical connection to an opposing connector. In the embodiment illustrated in FIG. 1, the contact elements 56 are male contacts that are to be inserted into opposing receptors.

As shown in FIG. 1, the connector 50 further includes a gasket 58. The gasket 58 is for providing a fluid-tight connection when the connector is engaged with a complementary receptacle. The gasket can be made from any suitable elastomer or rubber. In one aspect, for instance, the gasket 58 is made from a silicone elastomer.

Referring to FIG. 2, another connector 60 made in accordance with the present disclosure is shown. The connector 60 is for receiving and attaching to the connector 50 as shown in FIG. 1. The connector 60 includes a base 62 that surrounds and forms walls around a plurality of contact elements 66. The contact elements 66 are female connectors for receiving the male contact elements 56 from connector 50 as shown in FIG. 1. As shown, the connector 60 also includes a gasket 68 similar to the embodiment illustrated in FIG. 1.

In accordance with the present disclosure, the base 54 of the connector 50 and the base 62 of the connector 60 can be made from the polymer composition of the present disclosure.

The present invention may be better understood with reference to the following examples.

### Test Methods

Tensile Modulus, Tensile Stress, and Tensile Elongation at Break: Tensile properties may be tested according to ISO Test No. 527:2012 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Unotched Charpy Impact Strength: Unotched Charpy properties may be tested according to ISO Test No. ISO 179-1:2010) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C.

Notched Charpy Impact Strength: Notched Charpy properties may be tested according to ISO Test No. ISO 179-1:2010) (technically equivalent to ASTM D256-10, Method B). This test may be run using a Type A notch (0.25 mm base radius) and Type 1 specimen size (length of 80 mm, width of 10 mm, and thickness of 4 mm). Specimens may be cut from the center of a multi-purpose bar using a single tooth milling machine. The testing temperature may be 23° C. or −30° C.

Comparative Tracking Index (“CTI”): The comparative tracking index (CTI) may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five (5) specimens withstand the test period for 50 drops without failure is determined. The test voltages range from 100 to 600 V in 25 V increments. The numerical value of the voltage that causes failure with the application of fifty (50) drops of the electrolyte is the “comparative tracking index.” The value provides an indication of the relative track resistance of the material. An equivalent method for determining the CTI is ASTM D-3638-12.

UL94: A specimen is supported in a vertical position and a flame is applied to the bottom of the specimen. The flame is applied for ten (10) seconds and then removed until flaming stops, at which time the flame is reapplied for another ten (10) seconds and then removed. Two (2) sets of five (5) specimens are tested. The sample size is a length of 125 mm, width of 13 mm, and thickness of 0.8 mm or 0.4 mm. The two sets are conditioned before and after aging. For unaged testing, each thickness is tested after conditioning for 48 hours at 23° C. and 50% relative humidity. For aged testing, five (5) samples of each thickness are tested after conditioning for 7 days at 70° C.

| Vertical | |
|---|---|
| Ratings | Requirements |
| V-0 | Specimens must not burn with flaming combustion for more than 10 seconds |
| | after either test flame application. |
| | Total flaming combustion time must not exceed 50 seconds for each set of 5 |
| | specimens. |
| | Specimens must not burn with flaming or glowing combustion up to the |
| | specimen holding clamp. |
| | Specimens must not drip flaming particles that ignite the cotton. |
| | No specimen can have glowing combustion remain for longer than 30 seconds |
| | after removal of the test flame. |
| V-1 | Specimens must not burn with flaming combustion for more than 30 seconds |
| | after either test flame application. |
| | Total flaming combustion time must not exceed 250 seconds for each set of 5 |
| | specimens. |
| | Specimens must not burn with flaming or glowing combustion up to the |
| | specimen holding clamp. |
| | Specimens must not drip flaming particles that ignite the cotton. |
| | No specimen can have glowing combustion remain for longer than 60 seconds |
| | after removal of the test flame. |
| V-2 | Specimens must not burn with flaming combustion for more than 30 seconds |
| | after either test flame application. |
| | Total flaming combustion time must not exceed 250 seconds for each set of 5 |
| | specimens. |
| | Specimens must not burn with flaming or glowing combustion up to the |
| | specimen holding clamp. |
| | Specimens can drip flaming particles that ignite the cotton. |
| | No specimen can have glowing combustion remain for longer than 60 seconds |
| | after removal of the test flame. |

### Example

A polyamide resin sample was formed from the following components:

| | (wt. %) |
|---|---|
| Nylon 6,6 | 36 |
| Nylon 6I/6T | 7.5 |
| Glass Fibers | 30 |
| Melam and Melem | 12.5 |
| Aluminum Phosphinate | 10 |
| Aluminum salt of a hydrogen phosphite | 2.5 |
| Dipentaerythritol | 1.5 |

The above formulation was tested for various properties and the following results were obtained:

| Properties | | | Example |
|---|---|---|---|
| Mechanical Properties | Test Standard | Unit | formulation |
| Tensile Modulus | ISO527-1, -2 | MPa | 11997 |
| Stress at break | ISO527-1, -2 | MPa | 154 |
| strain at break | ISO527-1, -2 | % | 2.4 |
| Charpy impact strength | ISO179-1, 1 eU | kJ/m2 | 8.8 |
| 23° C. | | | |
| Melting temperature, | ISO11357-3 | ° C. | 254 |
| 10° C./min | | | |
| Temp. of deflection under | ISO75-1, -2 | ° C. | 250 |
| load, 1.80 MPa | | | |
| Density | ISO1183-1 | kg/m3 | 1.45 |
| Flammability Flame Class | IEC 60695-11-10 | 0.4 mm | V0 |
| thickness | UL94 | | |
| CTI, PTI | IEC 60112 | V | 600 |
| GWIT @ 0.8 mm | IEC 60695-13 | ° C. | 800 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A polymer composition comprising a polyamide, a plurality of inorganic fibers, and a flame retardant system comprising a metal phosphinate, an aluminum salt as follows: 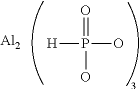
and a nitrogen-containing synergist, wherein at a thickness of 0.8 mm, the composition exhibits:
a Glow Wire Ignition Temperature of about 775° C. or more as determined in accordance with IEC-60695-2-13:2010;
a V0 rating as determined in accordance with UL94; and
a comparative tracking index of about 550 volts or more as determined in accordance with IEC 60112:2003.

2. A polymer composition as defined in claim 1, wherein the nitrogen-containing synergist displays less than 1% weight loss under a nitrogen atmosphere at a temperature of 300° C. and is present in the composition in an amount of from about 1% by weight to about 30% by weight.

3. A polymer composition as defined in claim 1, wherein the polyamide comprises an aliphatic polyamide.

4. A polymer composition as defined in claim 3, wherein the composition further contains a semi-aromatic polyamide, a wholly aromatic polyamide, or mixtures thereof.

5. A polymer composition as defined in claim 4, wherein the composition contains a semi-aromatic polyamide comprising polyamide 6I/6T.

6. A polymer composition as defined in claim 4, wherein the semi-aromatic or wholly aromatic polyamide is present in the composition in an amount from about 2% by weight to about 20% by weight.

7. The polyamide composition as defined in claim 1, wherein one or more polyamides constitute from about 30 wt. % to about 80 wt. % of the composition, inorganic fibers constitute from about 5 wt. % to about 50 wt. % of the composition, and the flame retardant system constitutes from about 5 wt. % to about 40 wt. % of the composition.

8. The polyamide composition as defined in claim 3, wherein the aliphatic polyamide is nylon-6, nylon-6,6, or a combination thereof.

9. The polyamide composition as defined in claim 1, wherein the inorganic fibers include glass fibers.

10. A polymer composition as defined in claim 1, wherein the metal phosphinate has one of the following chemical structures: 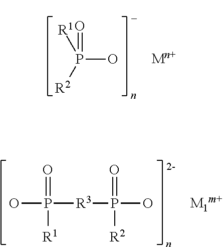
in which R¹, R² are the same or different and are each linear or branched C₁-C₆-alkyl; R³ is linear or branched C₁-C₁₀-alkylene, C₆-C₁₀-arylene, C₇-C₂₀-alkylarylene or C₇-C₂₀-arylalkylene; M is Mg, Ca, Al, Sb, Sn, Ge, Ti, Zn, Fe, Zr, Ce, Bi, Sr, Mn, Li, Na, K and/or a protonated nitrogen base; m is 1 to 4; n is 1 to 4; x is 1 to 4.

11. A polymer composition as defined in claim 1, wherein the nitrogen-containing synergist displays less than 1% weight loss under a nitrogen atmosphere at a temperature of from 200° C. to a temperature of 400° C.

12. A polymer composition as defined in claim 1, wherein the nitrogen-containing synergist comprises melam.

13. A polymer composition as defined in claim 1, wherein the nitrogen-containing synergist comprises melem.

14. A polymer composition as defined in claim 1, wherein the wherein the nitrogen-containing synergist comprises melam, melem, or mixtures thereof and is present in the polymer composition in an amount of from about 5% by weight to about 20% by weight.

15. A polymer composition as defined in claim 1, wherein the aluminum salt is present in the composition in an amount from about 0.8% by weight to about 6% by weight.

16. A polymer composition as defined in claim 1, wherein the metal phosphinate is present in the composition in an amount from about 5% by weight to about 30% by weight.

17. A polymer composition as defined in claim 1, wherein the composition further comprises a heat stabilizer.

18. A polymer composition as defined in claim 17, wherein the heat stabilizer comprises dipentaerythritol, the heat stabilizer being present in the polymer composition in an amount greater than about 0.5% by weight, and in an amount less than about 5% by weight.

19. A polymer composition as defined in claim 1, wherein the polymer composition contains polyamide 6,6 in an amount from about 20% by weight to about 45% by weight, contains polyamide 6I/6T in an amount from about 5% by weight to about 10% by weight, contains an aluminum phosphinate in an amount from about 7% by weight to about 15% by weight, contains the aluminum salt in an amount from about 1.5% by weight to about 4% by weight, contains glass fibers in an amount from about 25% by weight to about 35% by weight, and contains melam, melem or mixtures thereof in an amount from about 8% by weight to about 17% by weight.

20. A polymer composition as defined in claim 1, wherein the polymer composition displays a Charpy notched impact strength at 23° C. of greater than about 8 KJ/m², displays a tensile modulus of greater than about 10,000 MPa, displays a deflection temperature under a load of 1.80 MPa of greater than about 240° C., and displays a V0 rating as determined in accordance with UL94 at a thickness of 0.4 mm.

21. The polyamide composition as defined in claim 3, wherein the aliphatic polyamide is nylon-6,6 only and is in combination with a semi-aromatic polyamide.

22. An electrical connector that comprises opposing walls between which a passageway is defined for receiving a contact pin, wherein at least one of the walls contains the polyamide composition of claim 1.
